(19) United States
(12) Patent Application Publication
(10) Pub. No.: US 2007/0059472 A1
(43) Pub. Date: Mar. 15, 2007

(54) REPOSITIONABLE PHOTO MEDIA AND PHOTOGRAPHS

(75) Inventor: Jonathan P. Kitchin, Leander, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/461,129

(22) Filed: Jul. 31, 2006

Related U.S. Application Data
(63) Continuation-in-part of application No. 11/379,459, filed on Apr. 20, 2006.
Application No. 11/379,459 is a continuation-in-part of application No. 11/271,274, filed on Nov. 12, 2005.
Application No. 11/271,274 is a continuation-in-part of application No. 11/227,549, filed on Sep. 15, 2005.

(51) Int. Cl. B32B 33/00; G03C 3/00

(52) U.S. Cl. 428/40.1; 430/14

(57) ABSTRACT

A repositionable photo media and a repositionable photograph are provided. The repositionable photo media has a substrate having opposing first and second surfaces; an image receptive coating disposed on the first surface of the substrate; and a repositionable adhesive disposed on the second surface of the substrate; wherein the repositionable photo media a gloss value at 60° greater than about 25% and an adhesion to polyester of less than about 300 grams per inch and a static angle testing adhesion value of greater than about 600 seconds.

### CROSS REFERENCE TO RELATED APPLICATION

This application is a continuation in part of U.S. patent application Ser. No. 11/379,459 filed Apr. 20, 2006, which is a continuation in part of U.S. patent application Ser. No. 11/271,274 filed Nov. 12, 2005, which is a continuation in part of U.S. patent application Ser. No. 11/227,549 filed Sep. 15, 2005. This application is also related to U.S. patent application Ser. No. 11/271,219 filed Nov. 12, 2005, which is a continuation in part of U.S. patent application Ser. No. 11/227,604 filed Sep. 15, 2005.

### FIELD OF INVENTION

This invention pertains to a repositionable photo media and repositionable photographs. In particular, the photo media and photographs can be adhesively attached to a substrate for displaying and viewing.

### BACKGROUND

The use of digital cameras has increased in recent years. In digital photography, the consumer can capture the desired images using the digital camera, view the images almost instantaneously on the camera screen, and at a later time select which image, if any, should be printed on photo paper for display and viewing. With digital photography, the photographer has the ability to select the most desirable images from a repertoire of stored images.

There are a whole host of commercially available digital camera manufacturers, such as Canon, Sony Corporation, and Nikon Corporation, to name a few. One advantage of digital images is that they can be saved and stored in the camera's processor and later sent to a digital printer to generate a hard copy of the image for display, archiving, scrapbooking, and similar activities. Like the digital cameras, there are commercially available photo papers that a consumer can use to generate a hard copy of the image. Hewlett Packard, e.g., offers a variety of matte, semi-gloss, or glossy photo paper.

The company Hemmi Papilio Supplies (HPS) LLC in Rhome, Tex. supplies what is described as an inkjet high glossy adhesive photo paper. The paper is “self adhesive” and said to be suitable for all inkjet printers including Epson Durabrite™ printer. From the product catalog available as of the filing date of this application, this product (designation PGA8511) has a thickness of 0.008 inch and a liner of 0.0025 inch and includes a permanent adhesive. The same company also offers a satin gloss photo paper, also described as self adhesive, where the adhesive is permanent, under product designation SGA8511. The satin paper has a thickness of 8 mils on a 90# stay flat liner. Because these products contain permanent adhesive, once attached to a substrate, they most likely cannot be removed without damaging them.

The company AERO Komerciala, Celje, Slovenija, whose website as of the filing date of this application is www.aero.si, offers a Tix® Tape Mega Memo, which has been described in Aero's product literature as an A4 size paper (about 21 cm by 30 cm) having a removable adhesive stripes coated along the shorter edges, protected with two siliconized liner strips, each about 4 cm wide by 21 cm long.

The company ALFAC, Belgium, offers products under its DECAdry brand that includes photographic paper, referred to as PC Papers. As of the filing date of this application, on the www.decadry.com website, the 2005 catalog lists an Adhesive Photo Card product number OCI 4898, where the cards are 10 cm by 15 cm. The cards are said to be suitable for all inkjet printers and allows for sticking and taking off as often as desired. The cards are advertised to be glossy having a basis weight of 180 grams per square meter.

### SUMMARY

With the availability of digital cameras and with the advent of various digital printers, on demand printing has become commonplace behavior. There are consumers who prefer the ability to print the digital photos at their leisure. There is a need for quality, economically priced, repositionable photo media compatible with the digital printers.

The present invention relates to repositionable photo media and repositionable photographs intended to be consumable products. The repositionable photo media and photographs include a substrate, a repositionable adhesive, and optionally a liner to allow for easy one-step, print to display of the image. With the infrastructure available for creating, electronically saving, and printing digital photos, the inventive photo media is especially useful for generating and displaying the digital photos. Once done with displaying the photo, the consumer can archive the photo, if desired. In this way, photos can be updated on a regular basis and the photos can be displayed quickly without the need to use frames or alternative hardware. Photos can also be displayed on any horizontal or vertical surface that the repositionable adhesive can be adhered to, such as, e.g., refrigerators (without the need for using magnets), wood or plastic surfaces (without the need for using additional tape), fabrics, walls, and windows. The repositionable adhesive is selected to provide good adhesion to the intended surface and yet will not leave residue adhesive once the photo media has been removed.

In one aspect, the present invention pertains to a repositionable photo media comprising a substrate having opposing first and second surfaces; an image receptive coating disposed on the first surface of the substrate; and a repositionable adhesive disposed on the second surface of the substrate; wherein the repositionable photo media has a gloss value at 60° greater than about 25%, an adhesion to polyester of less than about 300 grams per inch, and a static angle testing adhesion value of greater than about 600 seconds.

In another aspect, the present invention pertains to a repositionable photograph comprising a substrate having opposing first and second surfaces; a photographic image disposed on the first surface of the substrate; a repositionable adhesive disposed on the second surface of the base sheet, wherein the repositionable photograph has a gloss value at 60° greater than about 25%, an adhesion to polyester of less than about 300 grams per inch, and a static angle testing adhesion value of greater than about 600 seconds.

In this document, the term “about” is presumed to modify all numerical values.

### BRIEF DESCRIPTION OF THE DRAWINGS

The invention can be better understood with reference to the following drawings, wherein:

FIG. 1 is an isometric view of an exemplary embodiment of the present invention; and

FIG. 2 is an isometric view of another exemplary embodiment of the present invention.

These figures are idealized, are not drawn to scale, and are intended merely for illustrative purposes.

### DETAILED DESCRIPTION

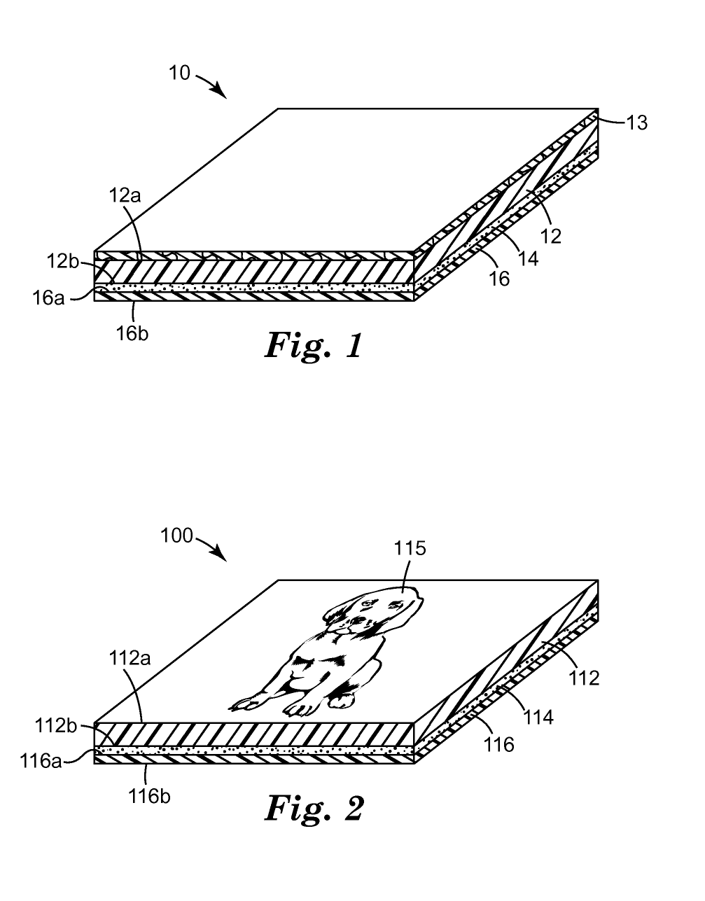

FIG. 1 shows one exemplary embodiment of the present invention. Repositionable photo media 10 includes substrate 12 having opposing first and second surfaces 12a and 12b respectively and image receptive coating 13 disposed on first surface 12a of the substrate. Repositionable adhesive 14 is disposed on second surface 12b of the substrate. In this particular embodiment, the repositionable adhesive covers substantially all of the second surface of the paper. The image receptive coating covers substantially all of the first surface of the paper. Disposed on the repositionable adhesive is liner 16, such that its first surface 16a contacts the repositionable adhesive.

FIG. 2 shows another exemplary embodiment of the present invention. Repositionable photograph 100 includes substrate 112 having opposing first and second surfaces 112a and 112b. Repositionable adhesive 114 is disposed on second surface 112b of the substrate. Photographic image 115 is disposed on the first surface of the substrate. The photographic image can be generated via inkjet printing, electrophotographic printing and dye sublimation. In one embodiment, the photographic image comprises an image receptive coating comprising oxides or silicates, as further described herein. In another embodiment, the photographic image comprises an image receptive coating comprising a swellable hydrophilic polymer. Optionally, liner 116 with its first surface 116a contacts the repositionable adhesive.

In one embodiment, the substrate has a minimum basis weight of 125 g/m². As used herein, the term basis weight is equivalent to its grammage and can be reported in units of grams per square meter (g/m²) or pounds per unit area, such as, e.g., pounds per 1300 ft². The basis weight of the substrate is the weight at the end of the paper making process and does not include any image receptive coating that may have been coated thereon in a separate coating operation. In another embodiment, the substrate has a minimum basis weight of 125 g/m² and a maximum basis weight of 210 g/m². Commercially available substrates are available from suppliers such as International Paper, Schoeller, and Domtar, Inc., to name a few.

In one embodiment, the substrate has a minimum thickness of 0.006 inch (0.15 mm). In another embodiment, the substrate has a minimum thickness of 0.006 inch and a maximum thickness of 0.009 inch (0.23 mm). While the basis weight of the substrate can be an indicator for its thickness, the thickness can also be measured using a conventional caliper, typically after the substrate has been conditioned in a controlled environment after a period of time. For example, it is acceptable industry practice to condition the substrate in a constant humidity temperature room, such as one that is set at 20° C., 50% relative humidity, for 24 hours.

Most inkjet printers have an upper limit on the thickness of the substrate that it will accept. Typically the upper thickness limit is in the range of 0.012 to 0.015 inch (0.30 to 0.38 mm). Thicker substrates will most likely face flexibility issues, as it must bend around the various mechanical rollers inside the printer. The repositionable photo media and repositionable photographs contain a multilayer construction where the substrate and the liner contribute most of the thickness. The liner has a typical thickness of 0.002 to 0.004 inch (0.05 to 0.10 mm). It has been found that at the upper of limit of 210 g/m² or at the upper limit of 0.009 inch in thickness, the substrate with the liner approaches the upper limit of most inkjet printers. There is an economic value of using thinner substrates or of a lower basis weight than the upper limit, as its cost is reduced. Also, it has been found at lower limit of 125 g/m² or at the lower limit of 0.006 inch in thickness, the substrate has feel more like conventional photo paper. At less than the minimum values, the substrate tends to be too thin to have the feel of conventional photo paper.

The image receptive coating covers the first side of the substrate. The image receptive coating can be of any composition that adheres to the substrate and is suitable for digital printing. Illustrative digital printing methods include as inkjet printing (both piezo and thermal), electrophotographic printing (including laser printing and color laser printing), and dye sublimation printing

When the image receptive coating is an inkjet receptive coating, suitable coatings would include two general classes of compositions: (1) those that absorb ink by capillary action, commonly described as porous, microporous, or nanoporous coatings, which may include silica, mixed oxides, and hydroxides of aluminum, and (2) those that include a hydrophilic polymer that absorbs ink by swelling, which are commonly referred to as swellable polymer coatings.

Suitable porous, microporous, or nanoporous coatings include U.S. Pat. No. 6,502,935 (Barcock et al.) and U.S. Pat. No. 6,830,798 (Misuda et al.).

Suitable swellable polymer, ink receptive coatings are described in U.S. Pat. No. 5,134,198 (Stofko, Jr. et al.), and U.S. Pat. No. 5,389,723 (Iqbal et al.). In very brief summary, both patents describe semi-interpenetrating polymer networks. These networks are blends of polymers where at least one of the polymeric components is crosslinked after blending to form a continuous network throughout the bulk material, and through which the uncrosslinked polymeric components are intertwined in such a way as to form a macroscopically homogeneous composition. Another suitable image receptive coating is described in U.S. Pat. No. 6,806,310 (Kopolow et al.), which discloses copolymers of dimethylaminopropyl methacrylamide (DMAPMA) and hydroxyethyl methacrylate (HEMA). It is stated that substrates coated with these copolymers are capable of absorbing the solvents, e.g., water or organic solvents, of digital printing inks rapidly with dry times of less than one minute. Yet another suitable image receptive coating is described in US Patent Application Publication No. US 2005/0027068, which discloses terpolymer compositions of vinyl caprolactam, DMAPMA, and HEMA to coat substrates for use in computer printers. Yet another useful ink receptive coating composition is disclosed in U.S. patent application Ser. No. 11/280,845 filed on Nov. 15, 2005.

In addition to generating digital photographs using a desktop inkjet photo printer, it is becoming increasingly common for consumers of digital photography to have their pictures printed using commercial retailers. For example, from a computer the consumer may upload digital picture files to an internet-based photo hosting website. These hosting websites allow consumers to store and organize their digital pictures. The websites also provide the service of making the digital pictures available for others related to the consumer, such as family and friends. The photo hosting websites can further provide a service whereby anyone who has permission to view a photograph that has been posted to the site can order a printed copy of the photograph. The printed copy may either be delivered by mail to a recipient's designated location or, in some cases, it may be sent to a nearby retail store that is designated by the recipient. Alternatively consumers may take a memory storage media (e.g., a flashcard) from their digital cameras to a photo kiosk or photo computer terminal at a retail photo processing store and order printed copies of selected digital photographs. In this particular case, the photographs may either be printed at the store or printed in a remote central location that supplies prints to multiple stores.

The commercial printing operations offer a benefit of providing a wider selection of print sizes than is typically available from the desktop inkjet photo printer. For example, poster size prints are commonly available from commercial printers in sizes of 12 by 18 inches or larger. The present invention is particularly advantageous in the case of poster-sized prints because they are specifically intended for display on the wall of a home or office. The inventive repositionable photo media can be removed multiple times without damaging the wall and without substantially curling the photo or leaving adhesive residue, which makes it especially useful in the case of poster sized digital prints.

Commercial printing operations can use inkjet printers to apply digital images to the repositionable photo media of the current invention. For reasons of printing cost and speed, however, it may be advantageous to use an electrophotographic imaging process. Electrophotographic printers are available from companies such as Hewlett Packard. Such printers include dry toner based printers (commonly referred to as “laser printers” or “color laser printers”) and liquid toner based printers (sometimes referred to as “digital presses”). For example, Hewlett Packard has its INDIGO brand digital presses.

In electrophotographic printing, the image is formed by electrostatic attraction between the toner particles and a pattern of electrostatic charge on a photoconductor drum. The electrostatic charge is produced by action of light on a charged photoconductor. A final full color image is built up on the drum (or belt) by sequential addition of yellow, magenta, cyan and black toner components (not necessarily in that order). The toner image is then transferred to a paper (typically referred to as “paper stock”) and fixed in place by a combination of heat and pressure.

The image receptive coating used in the repositionable photo media or repositionable photograph may be adapted to receive electrophotographic images. Electrophotographic image receptive coatings typically contain primarily inorganic silicates such as natural mineral clays and or calcium carbonate together with sufficient amount of organic polymer (such as styrene butadiene latex) to bind the coating together and confer mechanical strength and flexibility. Electrolytes or other electrically conductive materials may be added to the coating to control electrical conductivity.

Continuing now with the construction of the repositionable photo media and the repositionable photograph, the repositionable adhesive is disposed on the second side of the substrate. One suitable repositionable adhesive is a microsphere adhesive. An exemplary microsphere adhesive includes polyacrylic derivatives. The repositionable adhesive can be solvent based, water based, or can be a solventless, hot melt adhesive. Suitable repositionable adhesives includes those disclosed in the following US patents: U.S. Pat. No. 3,691,140 (Silver); U.S. Pat. No. 3,857,731 (Merrill et al.); U.S. Pat. No. 4,166,152 (Baker et al.); U.S. Pat. No. 4,495,318 (Howard); U.S. Pat. No. 5,045,569 (Delagado); U.S. Pat. No. 5,073,457 (Blackwell) and U.S. Pat. No. 5,571,617 (Cooprider et al.), U.S. Pat. No. 5,663,241 (Takamatsu et al.); U.S. Pat. No. 5,714,327 (Cooprider et al.); U.S. RE 37,563 (Cooprider et al.); and U.S. Pat. No. 5,756,625 (Crandall et al.); U.S. Pat. No. 5,824,748 (Kesti et al.); and U.S. Pat. No. 5,877,252 (Tsujimoto et al.).

The repositionable photo media of the present invention can be further characterized by two adhesion tests: (1) adhesion to polyester (specifically polyethylene terephthalate), and (2) static angle test (SAT). Both are described below in detail.

The adhesion to polyester test is performed by laminating a 1.25 inch (32 mm) strip of plain polyester, product designation OR16 film from 3M Company, St. Paul, Minn., over the previously coated and dried sample of repositionable adhesive. The polyester is laminated to the adhesive by using a 2 kg rubber coated roller rolling at a rate of 12 inch/min (25.4 mm/min). Using a stress/strain gauge, such as one available from Instron Corp., the polyester film is pulled away from the adhesive at a 90° angle at a peel rate of 12 inch/min (305 mm/min). The peel force is recorded in grams/inch.

The SAT measures the ability of the photo media with its repositionable pressure sensitive adhesive to remain adhered on a standard test panel while being subjected to removal pressure at a specified peel angle under a constant load. The static angle test is one quantitative procedure for measuring detachment resistance of the photo media.

In performing static angle test, six photo media samples can be prepared using the following exemplary process. The samples are all the same size, 33 mm wide by 76 mm long. Each sample of photo media includes an adhesive stripe that is 18 mm wide by 33 mm long, where the long dimension of each adhesive stripe is positioned along the short dimension of, and at the top of, each photo media sample.

The test panel is a steel panel with a painted surface. Each sample is applied to the painted steel panel with the long dimension of the adhesive stripe horizontally oriented and located at the top of the photo media sample. Then, the sample is pressure adhered to the painted steel surface by two passes of an application roller with an application pressure of 1.5 pounds per square inch (77.6 mm of mercury).

The mounted sample is placed in a holder frame that is vertically oriented approximately perpendicular to a ground surface. The painted steel panel is held at a 30° downward angle relative to the vertically oriented frame. A 100 gram load is applied to the lower end of the photo media sample, proximate to the lower end of the holder frame. A timer is started upon application of the 100 gram load to measure how long the sample remains attached to the painted steel surface before the photo media sample detaches from the steel panel. The SAT usually runs to failure, i.e., until the sample actually detaches form the steel panel. The time to detachment is usually measured in seconds as the average of six results.

The repositionable photo media and repositionable photograph has an adhesion to polyester value of 300 gram/inch (11.8 gram/mm) or less, preferably less than 200 gram/inch (7.9 gram/mm), and more preferably less than 160 gram/inch (6.3 gram/inch), and a SAT value of 600 seconds or greater, preferably 1800 seconds or greater. The lower the adhesion to polyester value, the easier it will be to remove the photo media from the substrate to which it has been attached. The higher the SAT value, the more likely the photo media will remain adhered to the intended substrate once it has been applied.

The liner covers and protects the repositionable adhesive and the substrate until it is imaged and ready for display. The liner can be any paper or plastic sheet that bonds to the repositionable adhesive securely during storage and while passing through the feed mechanism of a printer. The liner releases cleanly and easily from the repositionable adhesive after the photo media has been imaged. The liner may be treated with a release coating to achieve the desired release performance. The release coating would be disposed on the first surface of the liner such that it would be disposed on the repositionable adhesive. Suitable coatings include those that based on straight chain alkane derivatives, polydialkyl siloxane derivatives, or fluorocarbon derivatives. One exemplary release coating is described in U.S. Pat. No. 5,032,460 (Kanter et al.). The release coating will be applied on the liner, typically the entire surface area of the liner, to reach a dry coating weight of from 0.05 to 0.1 g/ft² (0.54 to 1.1 g/m²). Suitable silicone-based release liners are commercially available from Loparex, Inc., Willowbrook, Ill.

In one exemplary process, the photo media is made in a continuous process as follows. A substrate, typically in jumbo form, is provided. The image receptive coating is coated on the first side of the substrate using coating or printing processes. The coated substrate passes through a first drying unit, such as an oven. At a next station, to the second side of the base, the repositionable adhesive is applied in a desired pattern using coating or printing processes. Optionally, an additional primer coating may be interposed between the adhesive and the substrate. The adhesive coated substrate, whether or not primed, passes through a second drying unit. A liner is then laminated to the substrate such that the liner contacts the repositionable adhesive and the second side of the substrate. The liner can be scored to create precut segments, if desired, to facilitate the liner removal.

It has been further found that in the printing process used to produce the photo media of the present invention, paper with a basis weight of greater than 210 g/m² is harder to handle around the various mechanical equipments than paper having a basis weight less than 210 g/m² because of the weight and of the thickness of the paper.

The photo media can be wound into roll form and or converted into the desired size. Illustrative sizes include, but are not limited to, 4×6 inch, 5×7 inch, 8½×11 inch, and A4 size paper. The dry coating thicknesses of the image receptive coating and the repositionable adhesive should be sufficient to provide the desired product attributes, including features such as good print quality (good resolution of the image) and good bonding to a surface. In one embodiment, the dry coating thickness of the image receptive coating is greater than 3 microns and less than 30 microns.

Although specific embodiments of the present invention have been shown and described, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

What is claimed is:

1. A repositionable photo media comprising:
a substrate having opposing first and second surfaces;
an image receptive coating disposed on the first surface of the substrate; and
a repositionable adhesive disposed on the second surface of the substrate;
wherein the repositionable photo media has a gloss value at 60° greater than about 25% and an adhesion to polyester of less than about 300 grams per inch and a static angle testing adhesion value of greater than about 600 seconds.

2. The repositionable photo media of claim 1 having an adhesion to polyester of less than about 200 grams/inch and a static angle testing adhesion value of greater than about 1800 seconds.

3. The repositionable photo media of claim 1, wherein the repositionable adhesive is a microsphere adhesive.

4. The repositionable photo media of claim 1, wherein the repositionable adhesive comprises a polyacrylate derivative.

5. The repositionable photo media of claim 1, wherein the image receptive coating is a porous coating comprising oxides or silicates.

6. The repositionable photo media of claim 1, wherein the image receptive coating comprises a swellable hydrophilic polymer.

7. The repositionable photo media of claim 1 further comprising a liner having opposing first and second surfaces, the first surface disposed on the repositionable adhesive.

8. The repositionable photo media of claim 1, wherein the substrate has a gloss value at 60° of greater than about 40%.

9. The repositionable photo media of claim 1, wherein the substrate has a gloss value at 60° of greater than about 60%

10. A repositionable photograph comprising:
a substrate having opposing first and second surfaces and a photographic image disposed on the first surface of the substrate,
a repositionable adhesive disposed on the second surface of the base sheet,
wherein the repositionable photograph has a gloss value at 60° greater than about 25% and an adhesion to polyester of less than about 300 grams/inch and a static angle testing adhesion value of greater than about 600 seconds.

11. The repositionable photograph of claim 10 having an adhesion to polyester of less than about 200 grams/inch and a static angle testing adhesion value of greater than about 1800 seconds.

12. The repositionable photograph of claim 10, wherein the repositionable adhesive is a microsphere adhesive.

13. The repositionable photograph of claim 10, wherein the repositionable adhesive comprises a polyacrylate derivative.

14. The repositionable photograph of claim 10, wherein the photographic image comprises an image receptive coating comprising oxides or silicates.

15. The repositionable photograph of claim 10, wherein the photographic image comprises an image receptive coating comprises a swellable hydrophilic polymer.

16. The repositionable photograph of claim 10, wherein the photographic image is produced using an electrophotographic printer.

17. The repositionable photograph of claim 10, wherein the photographic image is produced using die sublimation printer.

18. The repositionable photograph of claim 10, wherein the photographic image is produced using a piezo inkjet printer.

19. The repositionable photograph of claim 10, wherein the photographic image is produced using a thermal inkjet printer.

20. The repositionable photo media of claim 10 further comprising a liner having opposing first and second surfaces, the first surface disposed on the repositionable adhesive.
